(19) United States
(12) Patent Application Publication
(10) Pub. No.: US 2021/0286212 A1
(43) Pub. Date: Sep. 16, 2021

(54) COLOR FILM SUBSTRATE, METHOD FOR MANUFACTURING THE SAME, DISPLAY DEVICE

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Jungho PARK, Beijing (CN); Fangzhuan LIU, Beijing (CN); Jingyong HU, Beijing (CN)

(21) Appl. No.: 16/321,610

(22) PCT Filed: Apr. 20, 2018
(86) PCT No.: PCT/CN2018/083868

§ 371 Date: Jan. 29, 2019

(30) Foreign Application Priority Data
Jun. 29, 2017 (CN) 201710515926.8

(51) Int. Cl. G02F 1/1335; G02B 5/20

(52) U.S. Cl. CPC G02F 1/133516; G02B 5/201

(57) ABSTRACT

A color film substrate, a method for manufacturing the same, and a display panel. The color film substrate including a basal substrate; a plurality of color resistance blocks arranged in an array on the basal substrate, the plurality of color resistance blocks including a red color resistance block, a green color resistance block, a blue color resistance block, and a yellow color resistance block. The heights of the plurality of color resistance blocks in the color film substrate are equal.

### RELATED APPLICATIONS

The present application is the U.S. national phase entry of the international application PCT/CN2018/083868, with an international filing date of Apr. 20, 2018, which claims the benefit of Chinese Patent Application No. 201710515926.8, filed on Jun. 29, 2017, the entire disclosures of which are incorporated herein by reference.

### TECHNICAL FIELD

The present disclosure relates to the field of display technology, and particularly to a color film substrate, a method for manufacturing the same, and a display panel.

### BACKGROUND

A liquid crystal display is a flat, ultra-thin display device that consists of a certain number of color pixels or black and white pixels. The power consumption of a liquid crystal display is very low; therefore, liquid crystal display is favored by users. Most liquid crystal displays generally display by using three primary colors, namely red, green and blue. With the constant pursuit of display quality by consumers, red, green, blue and white (RGBW) display technology has also emerged. This technology includes white sub-pixels. The advantage is that the brightness of the picture can be improved without applying more backlights. Thus, the three sub-pixels of red, green and blue form a brightness channel, and the white sub-pixel also forms a brightness channel, which greatly enhances the brightness of the display.

However, known color film substrates, the methods for manufacturing such color film substrates, and display panel employing such substrates can still benefit from improvement.

### SUMMARY

In an aspect of the present disclosure, a color film substrate is provided. The color film substrate includes: a basal substrate; a plurality of color resistance blocks arranged in an array on the basal substrate; the plurality of color resistance blocks including a red color resistance block, a green color resistance block, a blue color resistance block, and a yellow color resistance block. The heights of the plurality of color resistance blocks are equal. In this way, the display transmittance of the liquid crystal display fabricated using the color film substrate is improved, and the brightness uniformity of the display is also ensured.

In some exemplary embodiments, the yellow color resistance block is composed of a red color resistance section and a green color resistance section stacked in a direction perpendicular to the basal substrate.

In some exemplary embodiments, a ratio of a height of the red color resistance section to a height of the green color resistance section is in a range of 0.5 to 0.75.

In some exemplary embodiments, the yellow color resistance block is composed of a red color resistance section and a green color resistance section which are arranged in the same layer and adjacent to each other.

In some exemplary embodiments, a ratio of an area of the red color resistance section to an area of the green color resistance section is in a range of 0.6 to 0.75.

In another aspect of the present disclosure, a liquid crystal display panel is provided. The liquid crystal display panel includes the color film substrate according to any one of above-mentioned exemplary embodiments, a counter substrate arranged opposite to the color film substrate, and a liquid crystal layer arranged between the color film substrate and the counter substrate. The thicknesses of the liquid crystal layer at positions corresponding to the plurality of color resistance blocks are equal.

In yet another aspect of the present disclosure, method for manufacturing a color film substrate is provided. The method includes: providing a basal substrate; arranging a plurality of color resistance blocks on the basal substrate; the plurality of color resistance blocks including a red color resistance block, a green color resistance block, a blue color resistance block, and a yellow color resistance block. The heights of the plurality of color resistance blocks are equal.

In some exemplary embodiments, the yellow color resistance block is composed of a red color resistance section and a green color resistance section stacked in a direction perpendicular to the basal substrate; the red color resistance section and the red color resistance block are formed by the same composition process, and the green color resistance section and the green color resistance block are formed by the same composition process.

In some exemplary embodiments, the step of arranging a plurality of color resistance blocks on the basal substrate includes: arranging a red color resistance layer for forming the red color resistance block and the red color resistance section; forming the red color resistance block and the red color resistance section based on the red color resistance layer by a first composition process; arranging a green color resistance layer for forming the green color resistance block and the green color resistance section; forming the green color resistance block and the green color resistance section based on the green color resistance layer by a second composition process.

In some exemplary embodiments, a ratio of a height of the red color resistance section to a height of the green color resistance section is in a range of 0.5 to 0.75.

In some exemplary embodiments, the yellow color resistance block is composed of a red color resistance section and a green color resistance section which are arranged in the same layer and adjacent to each other; the red color resistance section and the red color resistance block are formed by the same composition process, and the green color resistance section and the green color resistance block are formed by the same composition process.

In some exemplary embodiments, the step of arranging a plurality of color resistance blocks on the basal substrate includes: arranging a red color resistance layer for forming the red color resistance block and the red color resistance section; forming the red color resistance block and the red color resistance section based on the red color resistance layer by a first composition process; arranging a green color resistance layer for forming the green color resistance block and the green color resistance section; forming the green color resistance block and the green color resistance section based on the green color resistance layer by a second composition process.

In some exemplary embodiments, a ratio of an area of the red color resistance section to an area of the green color resistance section is in a range of 0.6 to 0.75.

### BRIEF DESCRIPTION OF THE DRAWINGS

The above and/or additional aspects and advantages of the present disclosure will become apparent and easy to understand from the description of the embodiments in conjunction with the following drawings, in which:

FIG. 1 is a schematic cross-sectional view of a color film substrate according to an embodiment of the present disclosure;

FIG. 2 is a schematic cross-sectional view of a color film substrate according to another embodiment of the present disclosure;

FIG. 3 is a top view of a color film substrate according to another embodiment of the present disclosure;

FIG. 4 is a schematic cross-sectional view of a color film substrate of a related art;

FIG. 5 is a schematic cross-sectional view of a display panel according to an embodiment of the present disclosure; and

FIG. 6 is a flow chart of a method for manufacturing a color film substrate according to an embodiment of the present disclosure.

### DETAILED DESCRIPTION OF THE DISCLOSURE

Exemplary embodiments of the present disclosure are described in detail below, and exemplary embodiments of the embodiments are illustrated in the drawings, the same or similar reference numerals are used to refer to the same or similar elements or elements having the same or similar functions. The exemplary embodiments described below with reference to the accompanying drawings are intended to be illustrative only and are not to be construed as limiting the present disclosure.

In the description of the present disclosure, the orientations or positional relationships indicated by the terms “upper”, “lower” and the like are based on the orientation or positional relationship shown in the drawings; they are merely for convenience of description of the present disclosure and do not require that the disclosure should be constructed and operated in a particular orientation, and thus are not to be construed as limiting the disclosure.

The present disclosure has been made based on the following findings of the inventor.

At present, liquid crystal displays based on red, green, blue and white (RGBW) display technology generally have a problem of uneven brightness of the display screen. The inventor has found that this is mainly due to the segment differences between the red, green, blue and white color filters in the RGBW display technology of current liquid crystal displays. In the manufacturing process of the liquid crystal panel, in order to reduce the cost of the mask plate, a white color filter is mainly manufactured by using full-coating planarization film (OC film). The fluidity of the OC film is relatively high and the process cannot be well controlled. Therefore, during the manufacturing process, the white sub-pixels are generally in a recessed state with respect to the red, green and blue sub-pixels, so that after the cell alignment of the liquid crystal panel, the cell thickness corresponding to the white sub-pixel is larger than the cell thickness corresponding to the red, green or blue sub-pixel. In addition, the amount of liquid crystal corresponding to the white sub-pixel is relatively large, and the height of the spacer (PS) fluctuates greatly, and the brightness and transmittance of the white sub-pixel are thus higher than those of the adjacent red, green and blue sub-pixels. The display has the disadvantage of uneven brightness.

The present disclosure is intended to alleviate or solve at least one of the above mentioned problems to some extent.

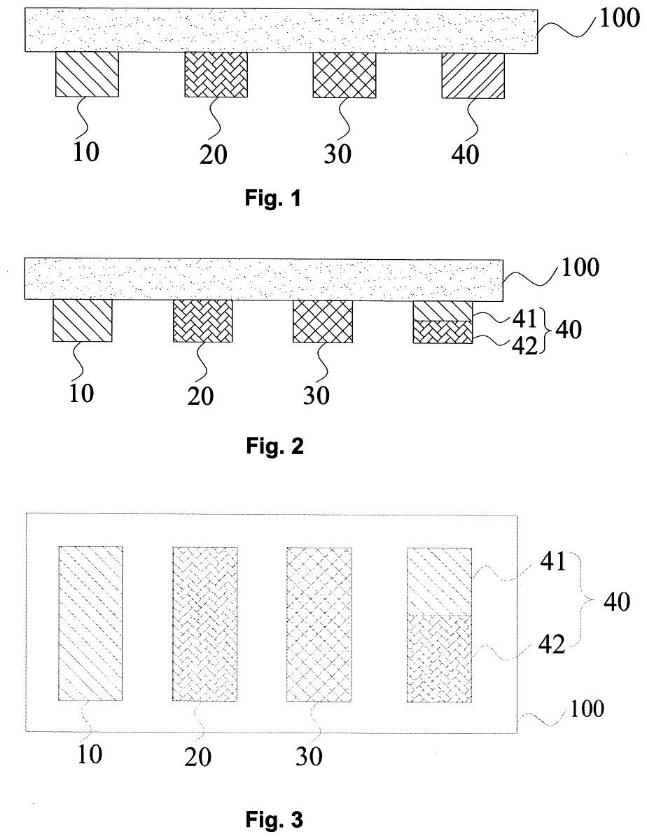

In an exemplary embodiment of the present disclosure, a color film substrate is provided. According to an exemplary embodiment of the present disclosure, as shown in FIG. 1, the color film substrate includes: a basal substrate 100; a plurality of color resistance blocks arranged in an array on the basal substrate 100; the plurality of color resistance blocks including a red color resistance block 10, a green color resistance block 20, a blue color resistance block 30, and a yellow color resistance block 40. The heights of the plurality of color resistance blocks are equal. In this way, the display transmittance of the liquid crystal display prepared by the color film substrate is improved, and the brightness uniformity of the display is also ensured.

In order to facilitate the understanding, the principle of improving the brightness of the display screen and ensuring the uniformity of brightness of the color film substrate will be briefly described below.

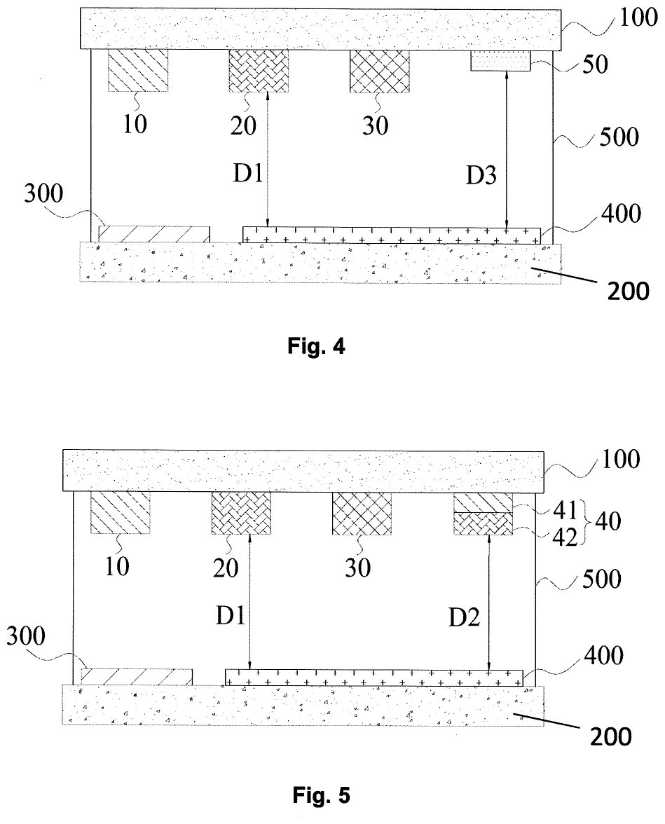

As mentioned above, the related art uses a planarization film to manufacture a white color resistance block, while the fluidity of the planarization film is relatively high and the process cannot be well controlled, thereby causing a certain segment difference between the white color resistance block and the red, green, and blue color resistance blocks. During the manufacturing process, the white sub-pixels are in a depressed state with respect to the red, green and blue sub-pixels, so that the cell thickness at the white sub-pixels are different to the cell thickness at the red, green and blue sub-pixels after the cell alignment, resulting in uneven display brightness. Specifically, referring to FIG. 4, the display panel based on the RGBW display technology includes a color film substrate and an array substrate. The array substrate includes a basal substrate 200, a thin film transistor 300, and a pixel electrode 400. The color film substrate and the array substrate are aligned with each other, thereby forming a display panel. The RGBW display technology is employed in the related art, and the color film substrate includes a red color resistance block 10, a green color resistance block 20, a blue color resistance block 30, and a white color resistance block 50. As described above, the white color resistance block 50 is formed of a planarization film, of which the fluidity is relatively high, and the process cannot be well controlled. This results in a depression at the white color resistance block 50, thus the white color resistance block 50 is lower than the red, green and blue color resistance blocks. Therefore, after the cell alignment, the cell thickness D3 at the white color resistance block 50 and the cell thickness at the red, green, and blue color resistance blocks (10, 20, and 30) (for example, the cell thickness at the green color resistance block 20, as indicated with D1) are not equal, which causes uneven brightness of the display.

According to an exemplary embodiment of the present disclosure, by optimizing the red, green, and blue sub-pixels, adjusting the proportion of the red color resistance block and the green color resistance block, a mixed color resistance block of the two colors can be obtained. Therefore, the white color resistance block 50 is replaced by a yellow color resistance block (Y), thereby producing a display panel with higher brightness, wider color gamut, and more sub-pixels. The inventor has found that the process controllability of the yellow color resistance block obtained by mixing the red color resistance block and the green color resistance block is superior to that of the planarization film material having a relatively high fluidity. Therefore, there is no depression at the position of the yellow sub-pixel, and the height of the yellow sub-pixel is consistent with the height of the red, green and blue sub-pixels. Moreover, the cell thickness at the yellow sub-pixel is equal to the cell thickness at the red, green and blue sub-pixels after the cell alignment, thereby improving the brightness of the display and ensuring the brightness uniformity.

Hereinafter, each structure of the color film substrate will be described in detail based on specific exemplary embodiments of the present disclosure.

According to an exemplary embodiment of the present disclosure, the color resistance block of the color film substrate includes a red color resistance block 10, a green color resistance block 20, a blue color resistance block 30, and a yellow color resistance block 40. Those skilled in the art can understand that for the red, green, and blue (RGB) three primary color display technology, the three primary colors of RGB are good for displaying colors such as purple and rose, but are slightly insufficient for other colors. According to the RGBY display technology proposed by exemplary embodiments of the present disclosure, the colors of the blue, green, and yellow colors are more abundant, and the yellow color as the transition color enhances the color gamut of the entire display screen, so that the display color is more delicate and rich.

According to an exemplary embodiment of the present disclosure, referring to FIG. 2, the yellow color resistance block 40 is composed of a red color resistance section 41 and a green color resistance section 42 stacked in a direction perpendicular to the basal substrate 100. The inventor has found that when light with a certain intensity is blocked by red, green and blue color resistance blocks, the ratio of brightness between red light, green light and blue light is about 3:9:1. Therefore, by using a mixture of red color resistance block and green color resistance block, a relatively high brightness can be obtained. That is to say, compared with the RGB primary color-based display, the color film substrate (of RGBY display) according to an exemplary embodiment of the present disclosure increases the percentage of the red and green color resistance blocks, thereby improving the brightness uniformity of the display screen and increasing the brightness of the display screen. According to an exemplary embodiment of the present disclosure, the height of the yellow color resistance block 40 (i.e., the sum of the height of the red color resistance section 41 and the height of the green color resistance section 42) is consistent with the heights of the red color resistance block 10, the green color resistance block 20, and the blue color resistance block 30. The white color resistance block 50 is replaced by the yellow color resistance block 40, thereby avoiding the uneven cell thickness caused by the segment difference between the red/green/blue resistance blocks and the white color resistance block. This ensures the effective control of the heights of the spacers and the amount of liquid crystal at the color resistance blocks of different colors, thus improving the brightness of the display.

According to the exemplary embodiment of the present disclosure, the yellow color resistance block 40 is formed by using the red color resistance section 41 and the green color resistance section 42. This is advantageous for controlling the height of the yellow color resistance block 40, so that a uniform cell thickness of the liquid crystal display panel applying the color film substrate can be obtained. This is also advantageous for simplifying the preparation process of the color film substrate without introducing materials other than the red, green and blue color resistance layer. The inventor has found that by adjusting the height ratio of the red color resistance section 41 to the green color resistance section 42, the brightness of the yellow color resistance block 40 can be adjusted. According to a specific exemplary embodiment of the present disclosure, the ratio of the height of the red color resistance section to the height of the green color resistance section may be in a range of 0.5 to 0.75. In this way, the brightness of the display screen can be further improved. Specifically, in certain exemplary embodiments, the height ratio of the red color resistance section 41 to the green color resistance section 42 may be 2:3.

According to an exemplary embodiment of the present disclosure, referring to FIG. 3, the yellow color resistance block 40 may be composed of a red color resistance section 41 and a green color resistance section 42 which are arranged in the same layer and adjacent to each other. The heights of the red color resistance section 41 and the green color resistance section 42 are equal, and the heights of the two color resistance sections are equal to the heights of the red color resistance block 10, the green color resistance block 20, and the blue color resistance block 30, thereby ensuring that the cell thickness at each sub-pixel is consistent. According to an exemplary embodiment of the present disclosure, the ratio of the area of the red color resistance section 41 to the area of the green color resistance section 42 may be in the range of 0.6 to 0.75, thereby further increasing the brightness of the display screen. Specifically, the area ratio of the red color resistance section 41 to the green color resistance section 42 may be 2:3.

According to an exemplary embodiment of the present disclosure, referring to FIG. 5, the color film substrate includes a red color resistance block 10, a green color resistance block 20, a blue color resistance block 30, and a yellow color resistance block 40. The yellow color resistance block 40 is composed of a red color resistance section 41 and a green color resistance section 42 such that the height of the yellow color resistance block 40 is equal to the heights of the red/green/blue color resistance blocks. After the color film substrate and the array substrate are aligned with each other, the cell thickness D2 at the yellow color resistance block 40 is equal to the cell thickness at the red, green, and blue color resistance blocks (e.g., D1 shown in FIG. 5), thereby improving the brightness of the display and the uniformity of the brightness of the display. It should be noted that, in the present disclosure, the specific heights of the red color resistance block 10, the green color resistance block 20, and the blue color resistance block 30 can be designed according to the specific conditions of the array substrate aligned with the color film substrate. That is, if a surface of the array substrate facing the color film substrate is not smooth (for example, a non-flat surface), the heights of the red color resistance block 10, the green color resistance block 20, and the blue color resistance block 30 may not be equal to each other, as long as the thicknesses of the liquid crystal layer at the positions corresponding to the plurality of color resistance blocks are equal.

In another aspect of the present disclosure, a liquid crystal display panel is provided. The liquid crystal display panel includes the color film substrate according to any one of above-mentioned exemplary embodiments, a counter substrate arranged opposite to the color film substrate, and a liquid crystal layer arranged between the color film substrate and the counter substrate. The thicknesses of the liquid crystal layer at positions corresponding to the plurality of color resistance blocks are equal. Therefore, the display panel has all the features and advantages of the color film substrate described above, and details are not described herein again. With the above arrangement, the display transmittance of the display panel is improved, and the uniformity of the brightness of the display screen is also ensured.

As shown in FIG. 5, in an exemplary embodiment, the liquid crystal display panel includes the color film substrate described in the above exemplary embodiments, a counter substrate disposed opposite to the color film substrate, and a liquid crystal layer 500 arranged between the color film substrate and the counter substrate. The thicknesses D1, D2 of the liquid crystal layer at positions corresponding to the plurality of color resistance blocks are equal.

In yet another aspect of the present disclosure, method for manufacturing a color film substrate is provided. According to an exemplary embodiment of the present disclosure, the color film substrate manufactured by the method is the color film substrate described above. Thus, the color film substrate manufactured by the method can have the same features and advantages as the color film substrate described above, which will not be described herein. According to an exemplary embodiment of the present disclosure, the method includes: providing a basal substrate; arranging a plurality of color resistance blocks on the basal substrate; the plurality of color resistance blocks including a red color resistance block, a green color resistance block, a blue color resistance block, and a yellow color resistance block. The heights of the plurality of color resistance blocks are equal. In this way, a color film substrate capable of improving the transmittance of the display screen and ensuring brightness uniformity of the display screen can be obtained.

In some exemplary embodiments, the yellow color resistance block is composed of a red color resistance section and a green color resistance section stacked in a direction perpendicular to the basal substrate; the red color resistance section and the red color resistance block are formed by the same composition process, and the green color resistance section and the green color resistance block are formed by the same composition process. In this way, a yellow color resistance block composed of a red color resistance section and a green color resistance section stacked in a direction perpendicular to the basal substrate can be obtained by a simple production process. According to a specific exemplary embodiment of the present disclosure, the height ratio of the red color resistance section to the green color resistance section may be 2:3, the brightness of the display screen can thus be further improved.

In some exemplary embodiments, the step of arranging a plurality of color resistance blocks on the basal substrate includes: arranging a red color resistance layer for forming the red color resistance block and the red color resistance section; forming the red color resistance block and the red color resistance section based on the red color resistance layer by a first composition process; arranging a green color resistance layer for forming the green color resistance block and the green color resistance section; forming the green color resistance block and the green color resistance section based on the green color resistance layer by a second composition process. In this way, the production processes of the method can be further simplified. It should be noted that the “composition process” in the above description may include processes such as photolithography, inkjet printing, and printing process, which can be designed by those skilled in the art according to actual conditions.

In some exemplary embodiments, a ratio of a height of the red color resistance section to a height of the green color resistance section is in a range of 0.5 to 0.75.

In some exemplary embodiments, the yellow color resistance block is composed of a red color resistance section and a green color resistance section which are arranged in the same layer and adjacent to each other; the red color resistance section and the red color resistance block are formed by the same composition process, and the green color resistance section and the green color resistance block are formed by the same composition process. In this way, a yellow color resistance block composed of a red color resistance section and a green color resistance section can be obtained by a simple production process, the red color resistance section and the green color resistance section are disposed in the same layer and adjacent to each other. According to a specific exemplary embodiment of the present disclosure, the ratio of the area of the red color resistance section to the area of the green color resistance section may be 2:3, thereby further improving the brightness of the display screen.

In some exemplary embodiments, the step of arranging a plurality of color resistance blocks on the basal substrate includes: arranging a red color resistance layer for forming the red color resistance block and the red color resistance section; forming the red color resistance block and the red color resistance section based on the red color resistance layer by a first composition process; arranging a green color resistance layer for forming the green color resistance block and the green color resistance section; forming the green color resistance block and the green color resistance section based on the green color resistance layer by a second composition process. It should be noted that the “composition process” in the above description may include processes such as photolithography, inkjet printing, and printing process, which can be designed by those skilled in the art according to actual conditions.

In some exemplary embodiments, the ratio of the area of the red color resistance section to the area of the green color resistance section is in a range of 0.6 to 0.75.

For example, according to a specific exemplary embodiment of the present disclosure, a red color resistance layer may be disposed on a substrate; then a red color resistance block and a red color resistance section are formed by a first composition process. In the first composition process, the thickness of the red color resistance section is smaller than the thickness of the red color resistance block. Subsequently, a green color resistance layer may be disposed on the substrate, and then a green color resistance block and a green color resistance section are formed by a second composition process.

In the second composition process, the thickness of the green color resistance section is smaller than the thickness of the green color resistance block. In this way, a yellow color resistance block composed of a red color resistance section and a green color resistance section can be formed. It can be understood by those skilled in the art that since the yellow color resistance block is composed of the red color resistance section and the green color resistance section stacked together, in the first composition process and the second composition process, the sum of the thickness of the red color resistance section and the thickness of the green color resistance section should be equal to the thicknesses of the red color resistance block and the green color resistance block, so that the cell thicknesses corresponding to the plurality of color resistance blocks of the color film substrate are equal. It should be noted that, in the present disclosure, the “first composition process” and the “second composition process” are only for distinguishing two composition processes and are not to be construed as limiting their importance or order. That is to say, in an exemplary embodiment, the first composition process may be performed first, or the second composition process may be performed first. The first composition process and the second composition process may use the same process or different composition processes. In the first composition process and the second composition process, the specific manner for controlling the thickness is not limited, and those skilled in the art can select the specific manner according to the specific composition process. For example, if the first composition process is photolithography, the red color resistance layer may be composed of a red color resistance glue, and the red color resistance glue is exposed and developed to form a red color resistance block and a red color resistance section. By controlling the exposure amount, the thickness of the color resistance glue can be controlled, thereby controlling the thicknesses of the red color resistance block and the red color resistance section. According to some exemplary embodiments of the present disclosure, the first composition process may also be inkjet printing. In this case, the thicknesses of the red color resistance block and the red color resistance section can be controlled by controlling the amount of inkjet material of the inkjet printing process. The second composition process may also have similar features to the first composition process described above, which will not be described herein.

According to some exemplary embodiments of the present disclosure, a yellow color resistance block composed of a red color resistance section and a green color resistance section may also be formed by a first composition process and a second composition process, in which the green color resistance section is arranged adjacent to the red color resistance section. It can be understood by those skilled in the art that when the yellow color resistance block is composed of the adjacently arranged red color resistance section and the green color resistance section: in the first composition process, the area of the red color resistance section is smaller than the area of the red color resistance block; in the second composition process, the area of the green color resistance section is smaller than the area of the green color resistance block. In this case, the thicknesses of the red color resistance section, the green color resistance section, the red color resistance block, and the green color resistance block are equal. The first composition process and the second composition process may also be photolithography or inkjet printing, and the like. According to an exemplary embodiment of the present disclosure, the first composition process is photolithography, and the area of the red color resistance section obtained after development can be made smaller than the area of the red color resistance block by controlling the shape of the exposure mask. Alternatively, the first composition process is inkjet printing, and the area of the red color resistance section obtained after development can be made smaller than the area of the red color resistance block by introducing a mask plate or controlling the amount of the material for inkjet printing.

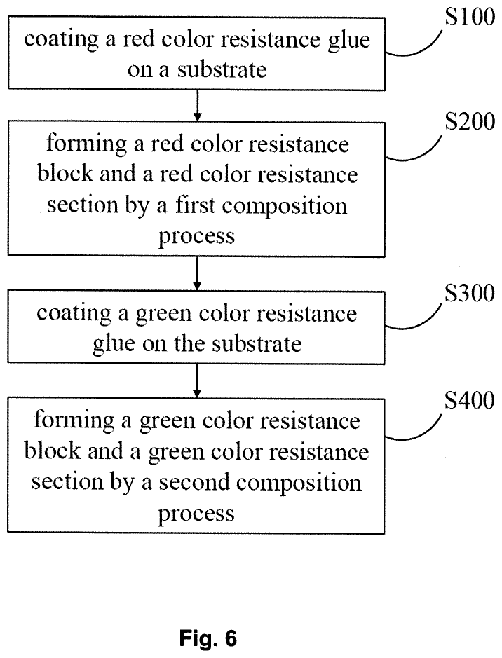

According to an exemplary embodiment of the present disclosure, referring to FIG. 6, the step of forming a red color resistance block, a green color resistance block, a blue color resistance block, and a yellow color resistance block by using a photolithography process may be as follows.

S100: coating a red color resistance glue on a substrate.

According to the exemplary embodiment of the present disclosure, in this step, a red color resistance glue is coated on the substrate, so that a red color resistance block and a red color resistance section can be subsequently formed by exposure, development, and the like.

S200: forming a red color resistance block and a red color resistance section by a first composition process.

According to an exemplary embodiment of the present disclosure, in this step, the red color resistance glue is subjected to a first composition process to obtain a red color resistance block and a red color resistance section. The first composition process may include exposing the color resistance layer formed of the red color resistance glue based on an exposure mask. Subsequently, the exposed red color resistance glue is developed to form a red color resistance block and a red color resistance section, and the remaining red color resistance glue is removed.

Specifically, if the yellow color resistance block is composed of a red color resistance section and a green color resistance section laminated in a direction perpendicular to the basal substrate, the thickness of the red color resistance block may be greater than the thickness of the red color resistance section. Specifically, on the exposure mask, the light transmission region for forming the red color resistance block may be the same to the light transmission region for forming the red color resistance section, so that the exposure amount at the red color resistance block is different from that at the red color resistance section. Specifically, the exposure amount at the red color resistance section may be 40% of the exposure amount at the red color resistance block, so that a red color resistance block and a red color resistance section having the same area and different heights may be obtained.

Similarly, if the yellow color resistance block is composed of a red color resistance section and a green color resistance section which are disposed in the same layer and adjacent to each other, the light transmission region of the exposure mask for forming the red color resistance block may be different from the light transmission region for forming the red color resistance section. Specifically, the area of the light transmission region corresponding to the red color resistance section may be 40% of the area of the light transmission region corresponding to the red color resistance block. By performing the exposure process using the same exposure amount, and performing development or the like, a red color resistance block and a red color resistance section having different heights and the same area can be obtained.

S300: coating a green color resistance glue on the substrate.

According to an exemplary embodiment of the present disclosure, in this step, a green color resistance glue is coated on the substrate, so that a green color resistance block and a green color resistance section can be subsequently formed by exposure, development, and the like.

S400: forming a green color resistance block and a green color resistance section by a second composition process.

According to an exemplary embodiment of the present disclosure, in this step, a second composition process is performed on the green color resistance glue to obtain a green color resistance block and a green color resistance section. Similarly, the second composition process may include exposing the color resistance layer formed of the green color resistance glue based on an exposure mask. Subsequently, the exposed green color resistance glue is developed to form a green color resistance block and a green color resistance section, and the remaining green color resistance glue is removed.

Specifically, if the yellow color resistance block is composed of a red color resistance section and a green color resistance section laminated in a direction perpendicular to the basal substrate, the thickness of the green color resistance block may be greater than the thickness of the green color resistance section. Specifically, on the exposure mask, the light transmission region for forming the green color resistance block may be the same to the light transmission region for forming the green color resistance section, so that the exposure amount at the green color resistance block is different from that at the green color resistance section. Specifically, the exposure amount at the green color resistance section may be 60% of the exposure amount at the green color resistance block, so that a green color resistance block and a green color resistance section having the same area and different heights may be obtained.

Similarly, if the yellow color resistance block is composed of a red color resistance section and a green color resistance section which are disposed in the same layer and adjacent to each other, the light transmission region of the exposure mask for forming the green color resistance block may be different from the light transmission region for forming the green color resistance section. Specifically, the area of the light transmission region corresponding to the green color resistance section may be 60% of the area of the light transmission region corresponding to the green color resistance block. By performing the exposure process using the same exposure amount, and performing development or the like, a green color resistance block and a green color resistance section having different heights and the same area can be obtained.

It should be noted that the order of forming the red color resistance block, the red color resistance section, the green color resistance block and the green color resistance section is not particularly limited, and those skilled in the art can determine the order according to specific conditions. For example, the red color resistance block and the red color resistance section may be manufactured first; alternatively, the green color resistance block and the green color resistance section may be manufactured first.

It can be understood by those skilled in the art that the blue color resistance block can be manufactured by first coating a blue color resistance glue on the basal substrate, and then performing exposing and development treatment to the blue resistance glue based on an exposure mask, so as to obtain the blue color resistance block. It should be noted that the order of manufacturing the blue color resistance block is not particularly limited, and those skilled in the art can design the manufacturing process according to actual conditions. For example, the blue color resistance block may be manufactured before manufacturing the red color resistance block, the red color resistance section, the green color resistance block, and the green color resistance section. Alternatively, the blue color resistance block may be manufactured after manufacturing the red color resistance block, the red color resistance section, the green color resistance block, and the green color resistance section.

In summary, according to the exemplary embodiment of the present disclosure, the RGBY display technology avoids the fluctuation of the segment difference between the sub-pixels in the RGBW display technology, which is favorable for the uniformity of the cell thickness of the display screen; the resolution and brightness of the display screen are improved. The yellow color display of the display screen is enhanced. The yellow color resistance block can be manufactured by using the mask plate(s) of the red color resistance block and the green color resistance block, which reduces the number of the mask plates and reduces the cost.

In the description of the present specification, the description of the terms “an exemplary embodiment”, “an embodiment”, “another embodiment” or the like means that the specific features, structures, materials or characteristics described in connection with the embodiments are included in at least one embodiment of the present disclosure. In the present specification, the schematic representation of the above terms is not necessarily directed to the same embodiment or example. Furthermore, the particular features, structures, materials, or characteristics may be combined in a suitable manner in any one or more embodiments or examples. In addition, combinations of different embodiments or examples described in the specification and features of the various embodiments or examples may be combined by those skilled in the art without contradicting each other.

While the exemplary embodiments of the present disclosure have been shown and described above, it is understood that the above-described exemplary embodiments are illustrative and are not to be construed as limiting the scope of the disclosure. Variations, modifications, alterations and variations of the above-described exemplary embodiments may be made by those skilled in the art within the scope of the present disclosure.

1. A color film substrate, comprising:
a basal substrate;
a plurality of color resistance blocks arranged in an array on the basal substrate; the plurality of color resistance blocks comprising a red color resistance block, a green color resistance block, a blue color resistance block, and a yellow color resistance block; and
wherein heights of the plurality of color resistance blocks are equal.

2. The color film substrate according to claim 1, wherein the yellow color resistance block is composed of a red color resistance section and a green color resistance section stacked in a direction perpendicular to the basal substrate.

3. The color film substrate according to claim 2, wherein a ratio of a height of the red color resistance section to a height of the green color resistance section is in a range of 0.5 to 0.75.

4. The color film substrate according to claim 1, wherein the yellow color resistance block is composed of a red color resistance section and a green color resistance section which are in a same layer and adjacent to each other.

5. The color film substrate according to claim 4, wherein a ratio of an area of the red color resistance section to an area of the green color resistance section is in a range of 0.6 to 0.75.

6. A liquid crystal display panel comprising the color film substrate according to claim 1, a counter substrate opposite to the color film substrate, and a liquid crystal layer between the color film substrate and the counter substrate;
wherein thicknesses of the liquid crystal layer at positions corresponding to the plurality of color resistance blocks are equal.

7. A method for manufacturing a color film substrate, comprising:
providing a basal substrate;
arranging a plurality of color resistance blocks on the basal substrate; the plurality of color resistance blocks comprising a red color resistance block, a green color resistance block, a blue color resistance block, and a yellow color resistance block; and
wherein heights of the plurality of color resistance blocks are equal.

8. The method according to claim 7, wherein the yellow color resistance block is composed of a red color resistance section and a green color resistance section stacked in a direction perpendicular to the basal substrate;
wherein the red color resistance section and the red color resistance block are formed by the same composition process, and the green color resistance section and the green color resistance block are formed by the same composition process.

9. The method according to claim 8, wherein arranging a plurality of color resistance blocks on the basal substrate comprises:
arranging a red color resistance layer for forming the red color resistance block and the red color resistance section;
forming the red color resistance block and the red color resistance section based on the red color resistance layer by a first composition process;
arranging a green color resistance layer for forming the green color resistance block and the green color resistance section; and
forming the green color resistance block and the green color resistance section based on the green color resistance layer by a second composition process.

10. The method according to claim 8 or 9, wherein a ratio of a height of the red color resistance section to a height of the green color resistance section is in a range of 0.5 to 0.75.

11. The method according to claim 7, wherein the yellow color resistance block is composed of a red color resistance section and a green color resistance section which are arranged in the same layer and adjacent to each other;
wherein the red color resistance section and the red color resistance block are formed by the same composition process, and the green color resistance section and the green color resistance block are formed by the same composition process.

12. The method according to claim 11, wherein arranging a plurality of color resistance blocks on the basal substrate comprises:
arranging a red color resistance layer for forming the red color resistance block and the red color resistance section;
forming the red color resistance block and the red color resistance section based on the red color resistance layer by a first composition process;
arranging a green color resistance layer for forming the green color resistance block and the green color resistance section; and
forming the green color resistance block and the green color resistance section based on the green color resistance layer by a second composition process.

13. The method according to claim 11, wherein a ratio of an area of the red color resistance section to an area of the green color resistance section is in a range of 0.6 to 0.75.

14. The method according to claim 9, wherein a ratio of a height of the red color resistance section to a height of the green color resistance section is in a range of 0.5 to 0.75.

15. The method according to claim 12, wherein a ratio of an area of the red color resistance section to an area of the green color resistance section is in a range of 0.6 to 0.75.

16. The liquid crystal display panel according to claim 6, wherein the yellow color resistance block is composed of a red color resistance section and a green color resistance section stacked in a direction perpendicular to the basal substrate.

17. The liquid crystal display panel according to claim 16, wherein a ratio of a height of the red color resistance section to a height of the green color resistance section is in a range of 0.5 to 0.75.

18. The liquid crystal display panel according to claim 6, wherein the yellow color resistance block is composed of a red color resistance section and a green color resistance section which are arranged in the same layer and adjacent to each other.

19. The liquid crystal display panel according to claim 18, wherein a ratio of an area of the red color resistance section to an area of the green color resistance section is in a range of 0.6 to 0.75.
